(19) United States
(12) Patent Application Publication
(10) Pub. No.: US 2026/0308415 A1
(43) Pub. Date: Oct. 8, 2026

(54) RADIATION CURABLE SILOXANE COMPOSITIONS AND METHODS FOR THEIR PREPARATION AND USE

(71) Applicants: Dow Silicones Corporation, Midland, MI (US); Dow Global Technologies LLC, Midland, MI (US)

(72) Inventors: Dongchan Ahn, Auburn, MI (US); Elena Montoto-Blanco, Chicago, IL (US); Vikram Prasad, Midland, MI (US); Shane Mangold, Auburn, MI (US); Myoungbae Lee, Auburn, MI (US); Christopher Tucker, Midland, MI (US)

(21) Appl. No.: 19/482,172

(22) PCT Filed: Jul. 19, 2024
(86) PCT No.: PCT/US2024/038634

§ 371 Date: Nov. 6, 2025

Related U.S. Application Data
(60) Provisional application No. 63/516,959, filed on Aug. 1, 2023.

(51) Int. Cl. C09D 183/10; C08G 77/44; C09D 4/00

(52) U.S. Cl. CPC C09D 183/10; C08G 77/44; C09D 4/00

(57) ABSTRACT

A curable composition includes an ethylenically unsaturated polydiorganosiloxane, a radical curable siloxane-urethane/urea copolymer, a reactive diluent, a crosslinker, and a photoinitiator. The composition can be cured by exposure to UV radiation. The composition can be used to form a transparent film with a Shore M hardness ≥35.

### CROSS REFERENCE TO RELATED APPLICATIONS

This application claims the benefit of U.S. Provisional Patent Application Ser. No. 63/516,959 filed on 1 Aug. 2023 under 35 U.S.C. § 119 (e). U.S. Provisional Patent Application Ser. No. 63/516,959 is hereby incorporated by reference.

### FIELD

This invention relates to a radiation curable composition including an ethylenically unsaturated polydiorganosiloxane, a siloxane-urethane/urea copolymer, and a reactive diluent. The composition can be cured to form a transparent coating.

### INTRODUCTION

Polyurethanes possess high cohesive strength and interfacial interactions leading to superior adhesion as well as toughening mechanisms, but typically suffer from high viscosities in absence of solvents. Polyorganosiloxanes possess weatherability, optical clarity, excellent wetting and flowability as well as a wide thermal range of use. Combinations of polyorganosiloxanes and polyurethanes are desirable to provide complimentary properties for use in products such as adhesives and coatings. However, urethanes and polyorganosiloxanes may suffer from the drawback of being immiscible with each other. While solvents can be used to improve the processability of urethane-containing polyorganosiloxanes, it is desirable to reduce the use of solvents, which are classified as volatile organic compounds (VOCs) for sustainability purposes.

### SUMMARY

A base siloxane composition comprises an ethylenically unsaturated polydiorganosiloxane, a radical curable siloxane-urethane/urea copolymer, and a reactive diluent. A crosslinker and a photoinitiator can be combined therewith to form a radiation curable siloxane composition. The radiation curable siloxane composition is useful for forming a transparent cured film, which may be useful as a conformal coating.

### DETAILED DESCRIPTION

The base siloxane composition introduced above comprises starting materials (A), (B), and (C), where starting material (A) is the ethylenically unsaturated polydiorganosiloxane, starting material (B) is the radical curable siloxane-urethane/urea copolymer, and starting material (C) is the reactive diluent, which is distinct from starting materials (A) and (B). Additional starting materials, i.e., (D) a crosslinker and (E) a photoinitiator can be combined with the base composition to form a radiation curable siloxane composition comprising starting materials (A), (B), (C), (D), and (E). The base siloxane composition comprising (A), (B), and (C); and/or the radiation curable siloxane composition, may further comprise one or more additional starting materials. The additional starting material may be selected from the group consisting of: (F) a filler, (G) a stabilizer, (H) a UV absorber, (I) an adhesion promoter, (J) an alkenyl functional polyorganosiloxane resin, and a combination of two or more thereof.

### (A) Ethylenically Unsaturated Polydiorganosiloxane

Starting material (A) in the composition introduced above is an ethylenically unsaturated polydiorganosiloxane. This ethylenically unsaturated polydiorganosiloxane may comprise unit formula (A1): (R⁴₃SiO_{1/2})ₐ(R⁴₂R⁵SiO_{1/2})_{b}(R⁴₂SiO_{2/2})_{c}(R⁴R⁵SiO_{2/2})_{d}, where each R⁴ is an independently selected monovalent hydrocarbyl group free of aliphatic unsaturation; each R⁵ is an ethylenically unsaturated monovalent hydrocarbyl group of 2 to 12 carbon atoms; subscripts a, b, c, and d, each represent an average number of siloxane units per molecule and have values such that 0≤a≤2, 0≤b≤2, (a+b)=2, c≥0, d≥0, 10≤(c+d)≤1,000, and (b+d)≥2. Alternatively, subscript a may be 0 and subscript b may be 2. Alternatively, the quantity (c+d) may be at least 10, alternatively at least 25, alternatively at least 50, alternatively at least 75, alternatively at least 100, and alternatively at least 125; while at the same time the quantity (c+d) may be up to 1,000, alternatively up to 750, alternatively up to 500, alternatively up to 260, alternatively up to 250, alternatively up to 200, and alternatively up to 180. Alternatively, subscript d may be 0 and subscript c may be 10 to 1,000. Alternatively, subscripts c and d may have values such that 10≤(c+d)≤1,000, alternatively 20≤(c+d)≤900, alternatively 30≤(c+d)≤800, alternatively 40≤(c+d)≤700, alternatively 50≤(c+d)≤600, alternatively 60≤(c+d)≤500, alternatively 70≤(c+d)≤400, alternatively 80≤(c+d)≤350, alternatively 90≤(c+d)≤300, alternatively 100≤(c+d)≤260, alternatively 100≤(c+d)≤200, and alternatively (c+d)=180.

Suitable monovalent hydrocarbyl groups for R⁴ are exemplified by alkyl groups and aryl groups. Suitable alkyl groups for R⁴ may be linear, branched, cyclic, or combinations of two or more thereof. The alkyl groups are exemplified by methyl, ethyl, propyl (including n-propyl and/or isopropyl), butyl (including n-butyl, tert-butyl, sec-butyl, and/or isobutyl); pentyl, hexyl, heptyl, octyl, decyl, dodecyl, undecyl, and octadecyl (and branched isomers having 5 to 18 carbon atoms), and the alkyl groups are further exemplified by cycloalkyl groups such as cyclopropyl, cyclobutyl, cyclopentyl, and cyclohexyl. Alternatively, the alkyl group for R⁴ may be selected from the group consisting of methyl, ethyl, propyl and butyl; alternatively methyl, ethyl, and propyl; alternatively methyl and ethyl. Alternatively, the alkyl group for R⁴ may be methyl. Alternatively, each R⁴ may be methyl.

Suitable aryl groups for R⁴ may be monocyclic or polycyclic and may have pendant hydrocarbyl groups. For example, the aryl groups for R⁴ include phenyl, tolyl, xylyl, naphthyl, benzyl, 1-phenylethyl and 2-phenylethyl. Alternatively, the aryl group for R⁴ may be monocyclic, such as phenyl, tolyl, or benzyl; alternatively the aryl group for R⁴ may be phenyl. Alternatively, each R⁴ may be independently selected from methyl and phenyl.

Each R⁵ is an independently selected ethylenically unsaturated group of 2 to 12 carbon atoms, such as alkenyl or alkynyl. Alternatively, each R⁵ may be an independently selected alkenyl group. The alkenyl group for R⁵ may have terminal alkenyl functionality, e.g., R⁵ may have formula

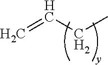

where subscript y is 0 to 6. Alternatively, each R⁵ may be independently selected from the group consisting of vinyl, allyl, and hexenyl. Alternatively, each R⁵ may be independently selected from the group consisting of vinyl and allyl.

Alternatively, each R⁵ may be independently selected from the group consisting of vinyl and hexenyl. Alternatively, each R⁵ may be vinyl.

Alternatively, in formula (A1) when subscript a=d=0, (A) the ethylenically unsaturated polydiorganosiloxane may comprise formula (A2):

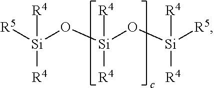

where R⁴, R⁵, and subscript c are as described above.

Alternatively, in formula (A2), each R⁴ may be alkyl, alternatively methyl; and each R⁵ may be independently selected from the group consisting of vinyl, allyl, and hexenyl, alternatively vinyl. In formula (A2), subscript c may be at least 10, alternatively at least 25, alternatively at least 50, alternatively at least 75, alternatively at least 100, and alternatively at least 125; while at the same time subscript c may be up to 1,000, alternatively up to 750, alternatively up to 500, alternatively up to 260, alternatively up to 250, alternatively up to 200, and alternatively up to 180. Alternatively, subscript d may be 0 and subscript c may be 10 to 1,000. Alternatively, in formula (A2), subscript c may have a value such that 10≤c≤1,000, alternatively 20≤c≤900, alternatively 30≤c≤800, alternatively 40≤c≤700, alternatively 50≤c≤600, alternatively 60≤c≤500, alternatively 70≤c≤400, alternatively 80≤c≤350, alternatively 90≤c≤300, alternatively 10≤c≤260, alternatively 10≤c≤200, alternatively 100≤c≤200, alternatively 140≤c≤200, alternatively 140≤c≤180, and alternatively c=180.

Starting material (A) may comprise an alkenyl-functional polydiorganosiloxane such as i) bis-dimethylvinylsiloxy-terminated polydimethylsiloxane, ii) bis-dimethylvinylsiloxy-terminated poly(dimethylsiloxane/methylvinylsiloxane), iii) bis-dimethylvinylsiloxy-terminated polymethylvinylsiloxane, iv) bis-trimethylsiloxy-terminated poly(dimethylsiloxane/methylvinylsiloxane), v) bis-trimethylsiloxy-terminated polymethylvinylsiloxane, vi) bis-dimethylvinylsiloxy-terminated poly(dimethylsiloxane/methylphenylsiloxane/methylvinylsiloxane), vii) bis-dimethylvinylsiloxy-terminated poly(dimethylsiloxane/methylphenylsiloxane), viii) bis-dimethylvinylsiloxy-terminated poly(dimethylsiloxane/diphenylsiloxane), ix) bis-phenyl,methyl,vinyl-siloxy-terminated polydimethylsiloxane, x) bis-dimethylhexenylsiloxy-terminated polydimethylsiloxane, xi) bis-dimethylhexenylsiloxy-terminated poly(dimethylsiloxane/methylhexenylsiloxane), xii) bis-dimethylhexenylsiloxy-terminated polymethylhexenylsiloxane, xiii) bis-trimethylsiloxy-terminated poly(dimethylsiloxane/methylhexenylsiloxane), xiv) bis-trimethylsiloxy-terminated polymethylhexenylsiloxane, xv) bis-dimethylhexenyl-siloxy terminated poly(dimethylsiloxane/methylphenylsiloxane/methylhexenylsiloxane), xvi) bis-dimethylvinylsiloxy-terminated poly(dimethylsiloxane/methylhexenylsiloxane), xvii) bis-dimethylhexenyl-siloxy-terminated poly(dimethylsiloxane/methylphenylsiloxane), xviii) dimethylhexenyl-siloxy-terminated poly(dimethylsiloxane/diphenylsiloxane), and xix) a combination of two or more of i) to xviii).

Methods of preparing the ethylenically unsaturated polydiorganosiloxanes described above for starting material (A), such as hydrolysis and condensation of the corresponding organohalosilanes and oligomers or equilibration of cyclic polydiorganosiloxanes, are known in the art, see for example U.S. Pat. Nos. 3,284,406; 4,772,515; 5,169,920; 5,317,072; and 6,956,087, which disclose preparing polydiorganosiloxanes with alkenyl groups. Examples of polydiorganosiloxanes having alkenyl groups are commercially available from, e.g., Gelest Inc. of Morrisville, Pennsylvania, USA under the tradenames DMS-V00, DMS-V03, DMS-V05, DMS-V21, DMS-V22, DMS-V25, DMS-V-31, DMS-V33, DMS-V34, DMS-V35, DMS-V41, DMS-V42, DMS-V43, DMS-V46, DMS-V51, and DMS-V52.

### (B) Radical Curable Siloxane-Urethane/Urea Copolymer

Starting material (B) is a radical curable siloxane-urethane/urea copolymer. This radical curable siloxane-urethane/urea copolymer may comprise formula (B1):

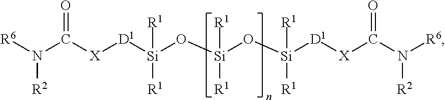

where each R² is an independently selected ethylenically unsaturated monovalent hydrocarbyl group, each R⁶ is independently selected from H or R², each X is independently selected from O or NH, each D¹ is a divalent hydrocarbyl group or an oxyhydrocarbyl group, each R¹ is an independently selected monovalent hydrocarbyl group that is free of aliphatic unsaturation, and subscript n≥0. In formula (B1), R¹ is as described and exemplified above for R⁴. The ethylenically unsaturated monovalent hydrocarbyl group for R² may be an alkenyl group, as described and exemplified above for R⁵. Alternatively, each R² may be independently selected from vinyl, allyl or hexenyl; alternatively allyl or hexenyl; and alternatively allyl. R⁶ may be R² or H. Alternatively, each R⁶ may be H. Each X may be O or NH. Alternatively, each X may be O. Each D¹ may be a divalent hydrocarbyl group or an oxyhydrocarbyl group. The divalent hydrocarbyl groups may be alkane-diyls such as ethylene (with empirical formula —C₂H₄—), propylene (with empirical formula —C₃H₆—), butylene (with empirical formula —C₄H₈—), or hexylene (with empirical formula —C₆H₁₂—), and the alkane-diyls may be linear or branched, e.g., D¹ may be

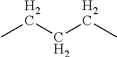

and/or

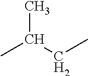

when the divalent hydrocarbyl group has 3 carbon atoms. Alternatively, D¹ may be an oxyhydrocarbyl group of formula —R⁷—O—R⁸—, where R⁷ and R⁸ are each independently selected monovalent hydrocarbyl groups, such as those described and exemplified above for R⁴. For example, the oxyhydrocarbyl group for D¹ may be selected from

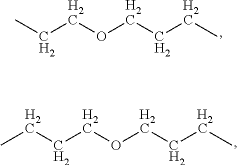

which are provided

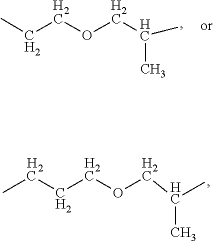

to be exemplary and not limiting. Subscript n has a value ≥0. Alternatively, subscript n may be at least 10, alternatively at least 20, alternatively at least 30, alternatively at least 40, alternatively at least 50 and alternatively at least 60, while at the same time, subscript n may have a value up to 150, alternatively up to 110, alternatively up to 100, alternatively up to 90, alternatively up to 80, alternatively up to 70, and alternatively up to 60. Alternatively, subscript n may have a value such that 10≤n≤150, alternatively 20≤n≤140, alternatively 25≤n≤130, alternatively 30≤n≤120, alternatively 40≤n≤110, alternatively 50≤n≤100, alternatively 55≤n≤90, alternatively 60≤n≤80, alternatively 50≤n≤70, and alternatively n=60. Alternatively, in formula (B1), each R⁶ may be H or allyl, each R² may be allyl, each X may be O, each D¹ may be an oxyhydrocarbyl group, and 20≤n≤100.

Alternatively, when each R⁶ is H, then starting material (B) comprises formula (B2):

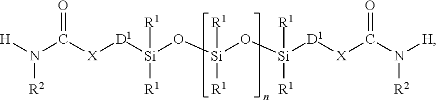

where R², X, D¹, R¹ and subscript n are as described and exemplified above. Alternatively, in formula (B2), each R² may be allyl, each X may be O, each D¹ may be an oxyhydrocarbyl group, and 20≤n≤100.

Alternatively, starting material (B) may comprise a copolymer of formula (B3):

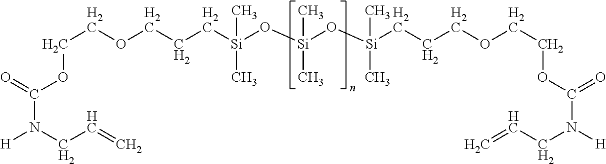

where subscript n has a value ≥0 and is as described and exemplified above. Alternatively, in formula (B2) or formula (B3), subscript n may be 50 to 70.

Starting material (B) the radical curable siloxane-urethane/urea copolymer may be prepared by known methods, such as reaction of a carbinol-functional polyorganosiloxane with an isocyanate compound, e.g., via the reaction described below in Synthesis Example 1 by varying appropriate starting materials. Suitable bis-carbinol-terminated polydimethylsiloxanes are commercially available, e.g., from Gelest, Inc. of Morrisville, Pennsylvania, USA with tradenames DMS-C15, DMS-C16, DMS-C21, and DMS-C23. Suitable isocyanates, such as allyl isocyanate, are commercially available from Sigma-Aldrich, Inc. of St. Louis, Missouri, USA.

### (C) Reactive Diluent

Starting material (C) is a reactive diluent. This reactive diluent comprises, per molecule, at least one radical curable group selected from the group consisting of vinyl, vinyl ether, acrylate, and methacrylate, and this reactive diluent has a solubility parameter δ≤19 (MPa)^{1/2} when estimated by method of Fedors, described below. The reactive diluent may have a weight average molecular weight (M_{w}) such that 100≤M_{w}≤500. The reactive diluent may have a viscosity <1,000 cP.

The reactive diluent may be vinyl-functional, e.g., may be a vinyl functional organosilicon compound. For example, the vinyl-functional organosilicon compound may have formula (C1):

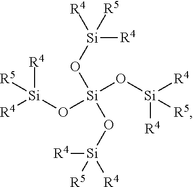

where R⁴ and R⁵ are as described above.

Alternatively, each R⁴ may be an alkyl group, such as methyl. Alternatively, each R⁵ may be selected from vinyl, allyl, and hexenyl; alternatively vinyl. The vinyl-functional organosilicon compound of the formula (C1) is known in the art, e.g., as disclosed in U.S. Pat. No. 6,806,339 to Cray, et al. Alternatively, when each R⁴ is methyl and each R⁵ is vinyl, formula (C1) is tetrakis(dimethyl(vinyl)silyl) silicate, which is commercially available from Fisher Scientific and TCI America. Tetrakis(dimethyl(vinyl)silyl)silicate has a solubility parameter of 15.1 (MPa)^{1/2} measured by the method of Fedors, described below.

Alternatively, (C) the reactive diluent may be a vinyl ether-functional compound. The vinyl ether-functional compound may be an alkane substituted with one or two vinyl ether moieties. For example, a linear, branched, cyclic (or combination thereof) alkane of 4 to 12 carbon atoms with one or two vinyl ether moieties per molecule. Examples of suitable vinyl ether-functional compounds include 1,4-cyclohexanedimethanol divinyl ether (which has solubility parameter of 17.4), isobutyl vinyl ether (which has solubility parameter of 15.3), dodecyl vinyl ether (which has solubility parameter of 16.6), and a combination of two or more thereof. These vinyl ether-functional compounds are commercially available from various sources, such as Sigma-Aldrich, Inc. of St. Louis, Missouri, USA and TCI America.

Alternatively, (C) the reactive diluent may be a (meth)acrylate-functional compound, e.g., an acrylate-functional compound or a methacrylate-functional compound. Examples of suitable methacrylate-functional compounds include isobornyl methacrylate (which has solubility parameter of 18.9), lauryl methacrylate (which has solubility parameter of 17.8), 3-methacryloxypropyltrimethoxysilane (which has solubility parameter of 17.7), and a combination of two or more thereof. Examples of suitable acrylate-functional compounds include vinyl laurate (which has solubility parameter of 17.8).

The base siloxane composition introduced above comprises starting materials (A), (B), and (C); alternatively consists essentially of starting materials (A), (B), and (C); and alternatively consists of starting materials (A), (B), and (C). The base siloxane composition may comprise 35 weight % to <50 weight % of starting material (A), 35 weight % to <50 weight % of starting material (B) and >0 to 30 weight % of starting material (C), where combined weights of (A), (B), and (C) total 100 weight %. Alternatively, one or more additional starting materials may be added to the base siloxane composition. For example, the base siloxane composition including (A), (B) and (C) may further comprise an additional starting material, where the additional starting material may be selected from the group consisting of: (F) a filler, (G) a stabilizer, (H) a UV absorber, (I) an adhesion promoter, (J) an alkenyl functional polyorganosiloxane resin, and a combination of two or more thereof. Alternatively, the composition including (A), (B), and (C) may be a radiation curable composition further comprising (D) a crosslinker, and (E) a photoinitiator, and optionally an additional starting material that may be selected from the group consisting of: (F) the filler, (G) the stabilizer, (H) the UV absorber, (I) the adhesion promoter, (J) the alkenyl functional polyorganosiloxane resin, and a combination of two or more thereof.

### (D) Crosslinker

Starting material (D) is a crosslinker that may be added to the base siloxane composition described above to form the radiation curable siloxane composition and facilitate cure. Suitable crosslinkers comprise sulfur. Examples of suitable polythiol crosslinkers for use in the present invention include, but are not limited to: glycol dimercaptoacetate (GDMA) (CAS #123-81-9); glycol di(3-mercaptopropionate) (GDMP) (CAS #22504-50-3); trimethylolpropane tri(3-mercaptopropionate) (TMPMP) (CAS #33007-83-9); ethoxylated-trimethylolpropane tri(3-mercaptopropionate) (CAS #345352-19-4); tris[2-(3-mercaptopropionyloxy)ethyl]isocyanurate (TEMPIC) (CAS #36196-44-8); pentaerythritol tetramercaptoacetate (PETMA) (CAS #10193-99-4); pentaerythritol tetra(3-mercaptopropionate) (PETMP) (CAS #7575-23-7); dipentaerythritol hexa(3-mercaptopropionate) (DiPETMP) (CAS #25359-71-1); polycaprolactone tetra(3-mercaptopropionate)(PCL4MP 1350)(CAS #1622079-69-9); 1,4-bis(3-mercaptobutylyloxy) butane (CAS #594836-83-6); 1,3,5-tris(3-mercaptobutyloxethyl)-1,3,5-triazine-2,4,6 (1H,3H,5H)-trione; pentaerythritol tetrakis(3-mercaptopropionate) (CAS #31775-89-0); methyl thioglycolate (CAS #2365-48-2); (3-mercaptopropyl)trimethoxysilane (CAS #4420-74-0); 2,2′-(ethylenedioxy)diethanethiol (CAS #14970-87-7); hexa(ethylene glycol) dithiol (CAS #89141-22-0); (mercaptopropyl)methylsiloxane homopolymer (CAS #102783-03-9); (mercaptopropyl)methylsiloxane-dimethylsiloxane copolymer (CAS #102783-03-9); mercaptopropyl-terminated polydimethylsiloxane polymer (CAS #308072-58-4); thiol-terminated polydimethylsiloxane; mercaptothiolated polyhedral oligomeric silsesquioxane (POSS); and combinations thereof. Alternatively, the crosslinker may be a mercapto-functional organosilicon compound, such as (mercaptopropyl)methylsiloxane homopolymer; (mercaptopropyl)methylsiloxane-dimethylsiloxane copolymer; mercaptopropyl-terminated polydimethylsiloxane polymer; thiol-terminated polydimethylsiloxane; or a combination of two or more thereof. Alternatively, the crosslinker may be a (mercaptopropyl)methylsiloxane-dimethylsiloxane copolymer. Examples of mercaptopropyl terminated polydimethylsiloxane are commercially available e.g., under tradename DMS-SM21 from Gelest, Inc. (Mercaptopropyl)methylsiloxane-dimethylsiloxane copolymers with varying molecular weights are also commercially available, e.g., under tradenames SMS-022, SMS-042, SMS-142, and SMS-992 from Gelest, Inc.

### (E) Photoinitiator

Starting material (E) is a photoinitiator that may be added to the base siloxane composition described above to form the radiation curable siloxane composition. Examples of suitable photoinitiators include 1-hydroxycyclohexyl phenyl ketone; 2,2-dimethoxy-2-phenylacetophenone; xanthone; fluorenone; benzaldehyde; fluorene; anthraquinone; triphenylamine; carbazole; 3-methylacetophenone; 4-chlorobenzophenone; 4,4′-dimethoxybenzophenone; 4,4′-diaminobenzophenone; Michler's ketone; benzoin propyl ether; benzoin ethyl ether; benzyl dimethyl ketal, 1-(4-isopropylphenyl)-2-hydroxy-2-methylpropan-1-one; 2-hydroxy-2-methyl-1-phenylpropan-1-one; thioxanthone; diethylthioxanthone; 2-isopropylthioxanthone; 2-chlorothioxanthone; 2-methyl-1-[4-(methylthio)phenyl]-2-morpholino-propan-1-one; 2,4,6-trimethylbenzoyldiphenyl-phosphine oxide; and bis(2,6-dimethoxybenzoyl)-2,4,4-trimethylpentylphosphine oxide. Photoinitiators are commercially available, such as DAROCUR™ 1173 (available from Sigma-Aldrich), and Uvecryl P36 (with CAS #85340-63-2, available from Alfa Chemistry).

Starting materials (A), (B), (C), (D), and (E), each described above, are present in the radiation curable siloxane composition. The radiation curable siloxane composition comprises starting materials (A), (B), (C), (D), and (E) described above. Alternatively, the radiation curable siloxane composition may consist essentially of starting materials (A), (B), (C), (D), and (E). Alternatively, the radiation curable composition may consist of (A), (B), (C), (D), and (E). Based on combined weights of starting materials (A), (B), (C), (D), and (E), each starting material may be present in the radiation curable siloxane composition in the following amounts. Starting material (A) the ethylenically unsaturated polydiorganosiloxane may be present in an amount of 30 weight % to 40 weight %. Starting material (B), the radiation curable siloxane-urethane copolymer, may be present in an amount of 30 weight % to 40 weight %. Starting material (C) the reactive diluent may be present in an amount of >0 to 25 weight %, alternatively 1 weight % to 5 weight %. Starting material (D) the crosslinker may be present in an amount of 20 weight % to 35 weight %. And, starting material (E) the photoinitiator may be present in an amount of >0 to 2 weight %, alternatively 0.25 weight % to 1.1 weight %. The amounts of starting materials (A), (B), (C), (D), and (E) in the radiation curable siloxane composition may total 100 weight %.

Alternatively, the base siloxane composition including starting materials (A), (B), and (C), and/or the radiation curable siloxane composition including starting materials (A), (B), (C), (D), and (E) may further comprise one or more additional starting materials. The additional starting material may be added in an amount that may provide a benefit provided it does not detrimentally impact performance of the composition, e.g., provided the additional starting material does not cause the base siloxane composition including starting materials (A), (B), and (C) to phase separate and/or does not detrimentally impact ability to cure the radiation curable siloxane composition including materials (A), (B), (C), (D), and (E). The type and amount of additional starting material depends on various factors including the type and amount of other starting materials used and the end use of the composition and/or the cured product thereof. However, 0 to 30 weight % of an additional starting material may be added, provided that the combined amounts of starting materials (A), (B), (C), (D), and (E) and the additional starting material total 100 weight %.

### (F) Filler

A filler may be added to the compositions described above, depending on the properties desired in the product to be made (e.g., a conformal coating made by curing the radiation curable siloxane composition). Thus, fillers may be solid or liquid, organic or inorganic, and may include reactive and non-reactive siloxanes, and/or acrylonitrile-butadiene rubbers; reactive and non-reactive thermoplastics (including but not limited to: poly(ether imides), maleimide-styrene terpolymers, polyarylates, polysulfones and polyethersulfones) inorganic fillers such as silicates (such as talc, clays, silica, and mica), glass, carbon nanotubes, graphene, and cellulose nanocrystals, including combinations of all of the foregoing.

Alternatively, a polyorganosiloxane resin may be included as the filler. The polyorganosiloxane resin may comprise monofunctional units (“M” units) of formula R^{M}₃SiO_{1/2} and tetrafunctional units (“Q” units) of formula SiO_{4/2}, where each R^{M} is an independently selected monovalent hydrocarbyl group. Suitable monovalent hydrocarbyl groups for R^{M} may have 1 to 20 carbon atoms, alternatively 1 to 12 carbon atoms, alternatively 1 to 8 carbon atoms, alternatively 1 to 4 carbon atoms, and alternatively 1 to 2 carbon atoms. Alternatively, the hydrocarbyl groups for R^{M} may be selected from the group consisting of alkyl groups and aryl groups; alternatively alkyl. The alkyl groups are exemplified by methyl, ethyl, propyl (e.g., iso-propyl and/or n-propyl), butyl (e.g., isobutyl, n-butyl, tert-butyl, and/or sec-butyl), pentyl (e.g., isopentyl, neopentyl, and/or tert-pentyl), hexyl, heptyl, octyl, nonyl, and decyl, as well as branched saturated monovalent hydrocarbyl groups of 6 or more carbon atoms including cycloalkyl groups such as cyclopentyl and cyclohexyl. The aryl groups are exemplified by cyclopentadienyl, phenyl, tolyl, xylyl, anthracenyl, benzyl, 1-phenylethyl, 2-phenylethyl, and naphthyl. Monocyclic aryl groups may have 5 to 9 carbon atoms, alternatively 6 to 7 carbon atoms, and alternatively 5 to 6 carbon atoms. Polycyclic aryl groups may have 10 to 17 carbon atoms, alternatively 10 to 14 carbon atoms, and alternatively 12 to 14 carbon atoms. Alternatively, each R^{M} may be selected from methyl and phenyl. Alternatively, at least one-third, alternatively at least two thirds of the R^{M} groups are methyl groups. Alternatively, the M units may be exemplified by (Me₃SiO_{1/2}) and (Me₂PhSiO_{1/2}). The resin is soluble in solvents exemplified by liquid hydrocarbons, such as benzene, toluene, xylene, ethyl benzene, heptane, and combinations of two or more thereof; or in liquid organosilicon compounds such as low viscosity linear and cyclic polydiorganosiloxanes.

When prepared, the polyorganosiloxane resin may comprise the M and Q units described above, and further comprises units with silanol (silicon bonded hydroxyl) groups and may comprise neopentamer of formula Si(OSiR^{M}₃)₄, where R^{M} is as described above. Si²⁹ Nuclear Magnetic Resonance (NMR) spectroscopy, as described in U.S. Pat. No. 9,593,209 at col. 32, Reference Example 2, may be used to measure molar ratio of M and Q units, where said ratio is expressed as {M(resin)+(M(neopentamer)}/{Q(resin)+Q(neopentamer)} and represents the molar ratio of the total number of triorganosiloxy groups (M units) of the resinous and neopentamer portions of the resin to the total number of silicate groups (Q units) in the resinous and neopentamer portions.

The Mn of the above described resin depends on various factors including the types of hydrocarbyl groups represented by R^{M} that are present. The Mn of the resin refers to the number average molecular weight measured using GPC according to the procedure in U.S. Pat. No. 9,593,209 at col. 31, Reference Example 1, when the peak representing the neopentamer is excluded from the measurement. The Mn of the resin may be greater than 3,000 g/mol, alternatively >3,000 g/mol to 8,000 g/mol. Alternatively, Mn of the resin may be 4,500 g/mol to 7,500 g/mol.

U.S. Pat. No. 8,580,073 at col. 3, line 5 to col. 4, line 31, is hereby incorporated by reference for disclosing silicone resins, which are suitable resins for use herein. The resin can be prepared by any suitable method, such as cohydrolysis of the corresponding silanes or by silica hydrosol capping methods. The resin may be prepared by silica hydrosol capping processes such as those disclosed in U.S. Pat. No. 2,676,182 to Daudt, et al.; U.S. Pat. No. 4,611,042 to Rivers-Farrell et al.; and U.S. Pat. No. 4,774,310 to Butler, et al. The method of Daudt, et al. described above involves reacting a silica hydrosol under acidic conditions with a hydrolyzable triorganosilane such as trimethylchlorosilane, a siloxane such as hexamethyldisiloxane, or mixtures thereof, and recovering a copolymer having M-units and Q-units.

The resin may optionally further comprise difunctional units D of formula (R^{M}₂SiO_{2/2}) and/or trifunctional T units of formula (R^{M}SiO_{3/2}). Alternatively, the filler may comprise a polyorganosiloxane resin, such as an MQ resin and/or a T resin, optionally further comprising D units (e.g., the polyorganosiloxane resin may be an MDQ, DT, MDT, or MDTQ resin). Suitable resins for use as fillers in the compositions described herein are known in the art and are commercially available from The Dow Chemical Company of Midland, Michigan, USA, and are exemplified by solvent based resins such as DOWSIL™ RSN-0409 HR, RSN-0431, RSN-0804, RSN-0805, RSN-0806, RSN-0808, and RSN-0840; Flake resins such as RSN-0217, RSN-0220, RSN-0233, RSN-0249, RSN-0255, and RSN-6018. Alkoxy-functional resins include DOWSIL US-CF-2403, 2405, 3037, 3074, and 5314.

### (G) Stabilizer

The radiation curable siloxane composition may optionally comprise a stabilizer. For example, when the radiation curable siloxane composition comprises reactive (meth)acrylate groups, a viable free radical scavenger may be present to prevent premature gelation, either in storage or preparation for use, e.g. such as before coating on a substrate. Stabilizers comprising phenolic compounds are one class of such materials that may be used herein, including, for example, 4-methoxyphenol (MEHQ, methyl ether of hydroquinone), hydroquinone, 2-methylhydroquinone, 2-t-butylhydroquinone, t-butyl catechol, butylated hydroxy toluene, and butylated hydroxy anisole, and combinations thereof. Other stabilizers that may be used include potassium hydroxide, phenothiazine and anaerobic inhibitors, such as the NPAL type inhibitors (tris-(N-nitroso-N-phenylhydroxylamine) aluminum salt) from Albemarle Corporation, Baton Rouge, La.

### (H) UV Absorber

Starting material (H) is an optional UV absorber, which may be a dye or pigment, that may be added to the compositions described above. For example, a non-reactive dye or pigment that absorbs light, particularly UV light may be used. Suitable examples of such UV absorbers include, but are not limited to: (i) titanium dioxide (e.g., included in an amount of 0.05 weight % to 1 weight %, alternatively 0.1 weight % to 1 weight %, based on combined weights of all starting materials in the composition, and/or (ii) an organic ultraviolet light absorber such as a hydroxybenzophenone, hydroxyphenyl-benzotriazole, oxanilide, benzophenone, thioxanthone, hydroxyphenyltriazine, and/or benzotriazole ultraviolet light absorber (e.g., Mayzo BLS™ 1326). The organic ultraviolet light absorber may be present in an amount of 0.001 weight % to 4 weight %, alternatively 0.005 weight % to 2 weight %, based on combined weights of all starting materials in the radiation curable siloxane composition.

### (I) Reactive Resin

The resin described above for use as a filler may alternatively have terminal aliphatically unsaturated groups (e.g., alkenyl groups as described above for R⁵), which allow the resin to react with starting material (A) and/or (B). Without wishing to be bound by theory, it is thought that a polyorganosiloxane resin, e.g., an MQ resin having terminal aliphatically unsaturated groups (e.g., an alkenyl-functional MQ resin) may act as a co-compatibilizer or matrix component in the compositions described above. An MQ resin having terminal aliphatically unsaturated groups may be prepared by reacting the product of Daudt, et al. with an unsaturated organic group-containing endblocking agent and an endblocking agent free of aliphatic unsaturation, in an amount sufficient to provide from 3 to 30 mole percent of unsaturated organic groups in the final product. Examples of endblocking agents include, but are not limited to, silazanes, siloxanes, and silanes. Suitable endblocking agents are known in the art and exemplified in U.S. Pat. Nos. 4,584,355; 4,591,622; and 4,585,836. A single endblocking agent or a mixture of such agents may be used to prepare such resin.

### (J) Adhesion Promoter

Suitable adhesion promoters for starting material (J) include silane coupling agents such as alkyltrialkoxysilanes such methyltrimethoxysilane and/or methyltriethoxysilane; alkenyltrialkoxysilanes such as vinyltrimethoxysilane, vinyltriethoxysilane, allyltrimethoxysilane, allyltriethoxysilane, and combinations thereof; (meth)acryloxy-functional trialkoxysilanes such as 3-methacryloxypropyltrimethoxysilane and/or 3-methacryloxypropyl triethoxysilane; amino-functional trialkoxysilanes such as 3-aminopropyltrimethoxysilane, 3-aminopropyltriethoxysilane, N-(2-aminoethyl)-3-aminopropyltrimethoxysilane, and combinations thereof; mercapto-functional trialkoxysilanes such as gamma-mercaptopropyltrimethoxysilane; epoxy-functional trialkoxysilanes such as 3-glycidoxypropyltrimethoxysilane and/or 3-glycidoxypropyltriethoxysilane; and mixtures or reaction mixtures of said silane coupling agents. Alternatively, the adhesion promoter may comprise a tetraalkoxysilane such as tetramethoxysilane and/or tetraethoxysilane; and/or a dialkoxysilane such as dimethyldimethoxysilane, methylphenyldimethoxysilane, methylphenyldiethoxysilane; or other trialkoxysilane such as phenyltrimethoxysilane. Exemplary adhesion promoters are known in the art and are commercially available. For example, XIAMETER™ OFS-6020 Silane, XIAMETER™ OFS-6040 Silane, XIAMETER™ OFS-6070 Silane, XIAMETER™ OFS-6062 Silane, and XIAMETER™ OFS-6697 Silane are available from Dow.

### Other Additional Starting Materials

One skilled in the art would recognize that other additional starting materials may optionally be added to the compositions described herein. Examples include cure modifiers and/or photosensitizers. Given as examples of the photosensitizers are triethylamine, diethylamine, N-methyldiethanolamine, ethanolamine, 4-dimethylaminobenzoic acid, methyl 4-dimethylaminobenzoate, ethyl 4-dimethylaminobenzoate, isoamyl 4-dimethylaminobenzoate.

When selecting starting materials for the compositions described above, there may be overlap between types of starting materials because certain starting materials described herein may have more than one function. For example, certain alkoxysilanes may be useful as crosslinkers and as adhesion promoters. One skilled in the art would be able to select suitable additional starting materials for the compositions which are distinct from starting materials (A), (B), and (C), and when present, starting materials (D) and (E).

### Method of Making the Compositions Described Above

The compositions described above may be prepared by any convenient means using any convenient equipment. No special equipment or conditions are required. For example, the composition may be prepared by mixing starting materials (A), (B), and (C); and, when present, (D) and (E) to make the radiation curable siloxane composition at RT and ambient pressure. Optionally one or more of the additional starting materials described above may be added by mixing at RT and ambient pressure.

### Method of Use

The radiation curable siloxane composition described above may be used to form a cured film, such as a coating, e.g., a conformal coating, a release coating, a pressure sensitive adhesive, and/or a topcoat for a laminate article. The cured film may be transparent. A method for preparing the cured film may comprise forming the radiation curable siloxane composition described above into liquid film and exposing the liquid film to UV radiation, thereby forming the cured film.

The liquid film may be formed on a surface of a substrate. To improve bonding of the cured film to the substrate, the method for forming the cured film may optionally comprise treating the surface of the substrate before forming the liquid film of the radiation curable siloxane composition on the surface. Treating the surface may be performed by any convenient means, such as applying a primer, or subjecting the substrate to corona-discharge treatment, etching, or plasma treatment before applying the radiation curable siloxane composition to the surface so treated.

Preparing the liquid film, e.g., by applying the radiation curable siloxane composition to the surface of the substrate, can be performed by any convenient means. For example, a circular puck or a drawdown film method may be used. For the circular puck, composition may be poured onto a Teflon coated aluminum substrate with a stainless steel circular washer. Drawdowns may be done on substrates of Teflon, aluminum or FR4. Alternatively, the radiation curable siloxane composition may be applied onto a substrate by gravure coater, offset coater, offset-gravure coater, roller coater, and reverse-roller coater. Alternatively, applying the radiation curable siloxane composition to the surface of the substrate may be performed by a printing process such as screen printing, pin transfer, stencil printing, or inkjet printing. For example, use of the radiation curable siloxane composition described above as an ink in an inkjet printing process is contemplated herein. The liquid film applied on the surface of the substrate by any means described herein may be continuous, i.e., uniformly covering all or a portion of the surface of the substrate, which cures to form a continuous layer on the surface of the substrate. Alternatively, the liquid film may be discontinuous, for example when a printing process, such as inkjet printing, is used for applying the radiation curable siloxane composition in a discontinuous layer on the surface of the substrate. A discontinuous film may be applied, for example, when it is desired to form a pattern on the surface of the substrate. Suitable inkjet printing apparatus are known in the art and commercially available, for example, see the apparatus described in U.S. Patent Application Publication 2019/0292394 to Linton et al. at paragraphs [0052] to [0055].

The amount of the radiation curable siloxane composition to be applied to the surface substrate depends on various factors including whether a continuous or discontinuous coating layer is desired on the surface, the desired thickness of the film to be formed, and the specific end use application for the substrate having the cured film on its surface, however, the amount may be sufficient such that thickness of the coating may be >0 up to 3175 micrometers (0.125 inch), alternatively up to 2540 micrometers, and alternatively up to 1575 micrometers; after cure. Forming a liquid film and curing may be repeated one or more times to increase thickness of the cured film.

Exposing the liquid film to UV radiation may be performed by any convenient means using a commercially available ultraviolet irradiation apparatus, for example, a face type or a conveyer belt-type ultraviolet irradiation apparatus, where a lamp such as a low-pressure mercury lamp, a medium-pressure mercury lamp, a high-pressure mercury lamp, an ultrahigh-pressure mercury lamp, a xenon lamp, a metal halide lamp, an electrodeless lamp, an ultraviolet light-emitting diode, or a D-bulb ultraviolet lamp is used as the radiation source. The ultraviolet radiation dose may be 0.1 W/cm² to 10 W/cm² for 0.1 second to 120 seconds (=0.1 to 1200 J/cm²). The exact dose may be selected by one skilled in the art depending on various factors including the thickness of the liquid film.

The substrate can be any material that can withstand the conditions (described herein) used to cure the radiation curable siloxane composition to form the cured film on the substrate. For example, any substrate that can withstand exposure to UV radiation, and optionally heat treatment at a temperature equal to or greater than 120° C., alternatively 150° C. is suitable. Examples of materials suitable for such substrates including glasses or plastic films such as polyimide (PI), polyetheretherketone (PEEK), polyethylene naphthalate (PEN), liquid-crystal polyarylate, polyamideimide (PAI), polyether sulfide (PES), polyethylene terephthalate (PET). The substrate may be transparent, alternatively, substrates which are not transparent may be used provided that they allow the liquid film to be exposed to UV radiation. Alternatively, the substrate may be a component or layer of an (opto)electronic device.

### Examples

These examples are provided to illustrate the invention to one skilled in the art and are not to be construed to limit the scope of the invention set forth in the claims. The starting materials used in these examples are described in Table 1.

TABLE 1
Starting Materials

| Starting | | | |
|---|---|---|---|
| Material | | | |
| Type | Product Name | Chemical Description | Source |
| Component | SFD-119 | Bis-vinyl-terminated | DOWSIL ™ SFD- |
| (A-1) | | polydimethylsiloxane with | 119 Fluid from The |
| | | viscosity of 300-600 cP and | Dow Chemical |
| | | solubility parameter δ = 15.1 | Company |
| | | (MPA)^{1/2} | |
| Component | Terminal Dp60 | Allyl terminated urethane | Synthesized as |
| (B-1) | Si-PU | polydimethylsiloxane | described below in |
| | | | Synthesis Example |
| | | | 1 |
| Reactant | carbinol siloxane | Bis-carbinol terminated | DMS-C21 from |
| | | polydimethylsiloxane with | Gelest |
| | | viscosity 110 to 140 cSt and Mn = | |
| | | 4639 | |
| Solvent | THF | tetrahydrofuran | Sigma Aldrich |
| Reactant | Allyl isocyanate | H₂C═CH—CH₂—N═C═O | Sigma Aldrich |
| Reactant | IPDI | isophoronediisocyanate | Sigma Aldrich? |
| Catalyst | DBTDL | Dibutyl tin dilaurate | Sigma Aldrich? |
| Reactant | HEMA | hydroxyethylmethacrylate | Sigma Aldrich? |
| Inhibitor | MeHQ | 4-Methoxyphenol | Sigma Aldrich? |
| Component | HEMA chain | Methacrylate terminated | Synthesized as |
| (B-2) | extended Dp60 | polyurethane polydimethylsiloxane | described below in |
| | Si-PU | copolymer | Synthesis Example |
| | | | 2 |
| Crosslinker | SMS-022 | [2-3% (mercaptopropyl), | SMS-022 from |
| (D-1) | | methylsiloxane]-dimethylsiloxane | Gelest, Inc. |
| | | copolymer, 120-180 cSt | |
| Photoinitiator | Darocur 1173 | 2-hydroxy-2-methylpropiophenone | Sigma Aldrich |
| Reactive | Pentaerythritol | Pentaerythritol Allyl Ether with | Sigma Aldrich |
| diluent (C-1) | Allyl Ether | Mw = 176.2 g/mol | |
| Reactive | TMPTMA | trimethylolpropane trimethacrylate | Sigma Aldrich |
| diluent (C-2) | | with Mw = 338.4 g/mol | |
| Reactive | Triallyl | Triallyl Isocyanurate with Mw = | Fisher Scientific |
| diluent (C-3) | Isocyanurate | 249.3 g/mol | |
| Reactive | IBOMA | Isobornyl methacrylate with Mw = | Fisher Scientific |
| diluent (C-4) | | 222.3 g/mol | |
| Reactive | XIAMETER ™ | 3-Methacryloxypropyl | Dow |
| diluent (C-5) | OFS Z-6030 | Trimethoxysilane with Mw = 248.4 | |
| | Silane | g/mol | |
| Reactive | Lauryl | Lauryl Methacrylate with Mw = | Fisher Scientific |
| diluent (C-6) | Methacrylate | 254 g/mol | |
| Reactive | HDDA | 1,6-Hexanediol diacrylate with Mw = | Fisher Scientific |
| diluent (C-7) | | 226.3 g/mol | |
| Reactive | HDDMA | 1,6-Hexanediol dimethacrylate | Fisher Scientific |
| diluent (C-8) | | with Mw = 254.3 g/mol | |
| Reactive | TMPAA | trimethylolpropane allyl ether with | TCI America |
| diluent (C-9) | | Mw = 174.2 g/mol | |
| Reactive | Pentaerythritol | Pentaerythritol Triacrylate with | Fisher Scientific |
| diluent (C- | Triacrylate | Mw = 298.3 g/mol | |
| 10) | | | |
| Reactive | CHDM-di | 1,4-Cyclohexanedimethanol | Sigma Aldrich |
| diluent (C- | | divinyl ether with Mw = 196.3 | |
| 11) | | g/mol | |
| Reactive | | Trimethylpropaneformal Mono- | TCI Chemicals |
| diluent (C- | | acrylate with Mw = 200.2 g/mol | |
| 12) | | | |
| Reactive | Diurethane | Diurethane Dimethacrylate with | Sigma Aldrich |
| diluent (C- | Dimethacrylate | Mw = 470.6 g/mol | |
| 13) | | | |
| Reactive | HEMA | 2-Hydroxyethyl methacrylate with | Fisher Scientific |
| diluent (C- | | Mw = 130.1 g/mol | |
| 14) | | | |
| Reactive | M^{Vi}₄Q | Tetrakis(vinyldimethylsiloxy)silane | |
| diluent (C- | | with CAS# 60111-54-8 | |
| 15) | | | |
| Reactive | Isobutyl Vinyl | Isobutyl Vinyl Ether with Mw = | TCI America |
| diluent (C- | Ether | 100.2 g/mol | |
| 16) | | | |
| Reactive | Dodecyl Vinyl | Dodecyl Vinyl Ether with Mw = | Sigma Aldrich |
| diluent (C- | Ether | 212.4 g/mol | |
| 17) | | | |
| Reactive | Vinyl Laurate | Vinyl Laurate with Mw = 226.4 | TCI America |
| diluent (C- | | g/mol | |
| 18) | | | |
| Component | MM^{Vi}Q-resin | vinyl functional MQ resin, which is | Dow |
| (I-1) (added | | UV curable | |
| to SFD-119 | | | |
| for one | | | |
| example in | | | |
| Table 2) | | | |

DMS-C21 from Gelest, Inc. has formula

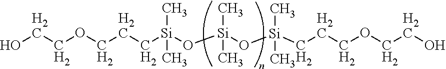

where subscript n has a value sufficient to give the carbinol siloxane the viscosity shown in Table 1, above.

In this Synthesis Example 1, component (B-1) the terminal Dp60 Si-PU shown above in Table 1 was synthesized as follows: The carbinol siloxane was dried prior to use (using a rotary evaporator at 100° C., 10 mbar, for 2 hours). A portion of the carbinol siloxane (41.0 grams, 8.56 mmol) was charged into a 250 mL, 4-necked flask equipped with nitrogen inlet, reflux condenser, stirring shaft, and dual thermometer probe connected to higher temperature cutoff unit. Nitrogen was blown over the carbinol siloxane for 30 minutes. THF was added (50 mL) and the contents stirred for 20 minutes to homogenize. Allylisocyanate (1.8 mL, 20.36 mmol) was added and the reaction mixture heated to 50° C. The contents were allowed to stir at 50° C. for 24 hours, with periodic monitoring of the progress of the reaction by NMR (conversion was determined by NMR as evidenced by disappearance of the methylene peak of the starting material at 3.7 ppm (CH2OH) and formation of product peak at 4.2 ppm (CH2OCONH)). Upon complete consumption of starting material, the material was cooled to room temperature. Residual allyl isocyanate and solvent was removed in vacuo (0.1 mmHg, 80° C.) to afford a clear fluid. Viscosity of the clear fluid was 156 cP determined using an Anton-Paar Physical MCR 301 rheometer fitted with a 25 mm stainless steel cone-in-plate fixture at a temperature of 25° C. at a shear rate of 10 s-1. The product was terminal Dp60 Si-PU of formula:

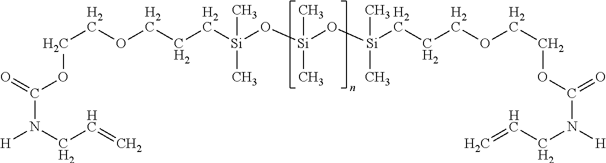

In this Synthesis Example 2, starting material (B-2) Hema chain extended Dp60 Si-PU was prepared as follows: The carbinol siloxane was dried at 90° C. overnight in a vacuum oven (0.1 in Hg) prior to reaction. The carbinol siloxane (70.80 g, 15.3 mmol) and isocyanate IPDI (6.75 g, 30.6 mmol) were charged into a 250 mL 4-necked flask fitted with an overhead mechanical stirrer, nitrogen inlet, dual probe thermocouple, heating mantle, and overhead temperature control shut off. The contents were stirred (~300 rpm) at room temperature for 15 minutes to homogenize. There was a slight exotherm from the reaction (internal temperature increased from 24° C. to 31° C.), so the reaction was continued to stir at room temperature for 2 hrs. The temperature of the contents was slowly increased to 40° C., upon which DBTDL catalyst (20 mg) was then added and the contents stirred at 40° C. for 2 hours. After this, nitrogen bubbling was stopped and a premixed solution of HEMA (4.01 g, 30.6 mmol), MeHQ inhibitor (40 mg), and DBTDL (18 mg) was added. The contents were allowed to stir at 40° C. for another 2 hours, after which complete disappearance of the NCO peak was observed by FTIR. The product was a clear, viscous fluid with Mn=12676, Mw=27966, and Viscosity 14386 cP (measured at 25° C., 10 s-1).

In this Reference Example 1, miscibility of (A) the alkenyl-functional polydiorganosiloxanes and (B) the radical curable organopolysiloxanes were demonstrated by i) Shaking together mixtures of (A) and (B) in a 1:1 weight ratio and (C) reactive diluents at different concentrations; then taking pictures of the resulting mixtures in 1 mL vials with a PICA II (Phase Imaging and Characterization Apparatus) device at different times and visually inspecting the images to determine whether the samples exhibited phase separation.

For the baseline case (control): 300 μL each of component (A-1) and component (B-1) described in Table 1 were added to a 1 mL vial. No reactive diluent was added. The vial was shaken vigorously and let sit for 24 hours, and then an image was taken with PICA IIU.

For the working and comparative examples: 300 μL each of component (A-1) and component (B-1), as described in Table 1, were added to a 1 mL vial. A reactive diluent described above in Table 1 at 5%, 10%, 15%, 20%, or 25% based on combined weights of (A-1), (B-1) and the reactive diluent, was also added to each vial. The vials were shaken well and let sit for 24 hours, then an image was taken with the PICA IIU. The range of the solubility parameter d of the reactive diluent was varied, such that 15<d<31.

The image of the baseline case demonstrated bulk phase separation; a hazy bottom phase and a clear top phase were visually observed. Similar behavior was seen with the sample containing pentaerythritol allyl ether, where the first three images showed bulk separation with the same 2 phases as the baseline case, while higher concentrations of pentaerythritol allyl ether resulted in bulk phase separation with at least 3 phases visible. In contrast, at all concentrations of IBOMA studied, the images were clear and did not demonstrate any bulk phase separation.

This process was repeated for numerous reactive diluent candidates with varying solubility parameters, the results of which are shown in Table 2, below. The values of 6 were calculated using the method of Fedors (see Fedors, R. F., Polym. Eng. Sci., V. 14, 147(1974)). The inventors found that for reactive diluents with d £19, no bulk phase separation was visually observed for a range of concentrations, and the samples were either clear, or exhibited haziness but were homogeneous.

TABLE 2
Compatibility Study Results

| Reactive Diluent | d (MPa)^{1/2} | 0% | 5% | 10% | 15% | 20% | 25% | IE/CE |
|---|---|---|---|---|---|---|---|---|
| Control: Baseline case, no | | X | N/A | N/A | N/A | N/A | N/A | CE |
| reactive diluent | | | | | | | | |
| Pentaerythritol Allyl Ether | 30.5 | X | X | X | X | X | X | CE |
| TMPTMA | 19.9 | X | X | X | X | X | X | CE |
| Triallyl Isocyanurate | 20.8 | X | X | X | X | X | X | CE |
| IBOMA | 18.9 | X | C | C | C | C | C | IE |
| 3-Methacryloxypropyl | 17.7 | X | HH | HH | HH | C | C | IE |
| Trimethoxysilane | | | | | | | | |
| Lauryl Methacrylate | 17.8 | X | HH | HH | HH | HH | HH | IE |
| HDDA | 19.6 | X | X | X | X | X | X | CE |
| HDDMA | 19.4 | X | X | X | X | X | X | CE |
| TMPAA | 25.3 | X | X | X | X | X | X | CE |
| Pentaerythritol Triacrylate | 23.6 | X | X | X | X | X | X | CE |
| CHDM-di | 17.4 | X | C | C | C | C | C | IE |
| Reactive Diluent C-12) | 19.1 | X | X | X | X | X | X | CE |
| Diurethane Dimethacrylate | 22.5 | X | X | X | X | X | X | CE |
| HEMA | 24.7 | X | X | X | X | X | X | CE |
| M^{Vi}₄Q | 15.1 | X | C | C | C | C | C | IE |
| Isobutyl Vinyl Ether | 15.3 | X | C | C | C | C | C | IE |
| Dodecyl Vinyl Ether | 16.6 | X | C | C | C | C | C | IE |
| Vinyl Laurate | 17.8 | X | C | C | C | C | C | IE |

Table 2 shows the results using reactive diluents that have allyl, vinyl or acrylate functionality used with combinations of components (A-1) and (B-1) at 1:1 wt ratio. In Table 2, the legends are: C=Clear and homogeneous, HH═Hazy and homogeneous, X=Phase separated, CE=comparative example, and IE=working example.

In this Example 2, mixture of component (A-1) (35.2 wt %), component (B-1) (35.2 wt %), reactive diluent (C-17) dodecyl vinyl ether (1.7 wt %), crosslinker (D-1) (27.5 wt %) and a photoinitiator (Darocur 1173, 0.5 wt %) was radiation-cured by means of a D-bulb UV lamp at 1380 mJ/cm². The resulting film was optically clear and homogeneous as observed by visual inspection.

In this Reference Example 3, results are shown in Table 3. Sample 3-1 the silicone control was component (A-1) by itself. Sample 3-2 the SiPU control was component (B-1) by itself. Sample 3-3 was a mixture of component (A-1) and component (B-1) in a 1:1 weight ratio, without reactive diluent or other components. Sample 3-4 was component (B-2) by itself. Samples 3-1 to 3-4 were comparative. Samples 3-5 to 3-9 each contained component (A-1) and component (B-1) in a 1:1 weight ratio with a reactive diluent added (selection and amount shown below in Table 3. Sample 3-10 contained a mixture of S component (A-1) and component (F-1) in a weight ratio 1:1 with component (B-1), and no reactive diluent. UV cured films were prepared by mixing each of samples 3-1 to 3-10 with crosslinker (D-1) in a 1.2:1 molar ratio of SH:ene groups and 0.5% photoinitiator. The films were cured at 3 J/cm². Shore M hardness and visual observations of the UV cured films are shown below in Table 3. In Table 3, CE=comparative example, and IE=working example.

TABLE 3

| | | | Average | | | |
|---|---|---|---|---|---|---|
| | | Diluent δ | Thickness | Average | Clarity/ | |
| Sample Name | miscibility | (MPa)^{1/2} | (in) | Shore M | Opacity | IE/CE |
| Silicone control | N/A | N/A | 0.07 | 26.9 ± 2 | Clear | CE |
| sample 3-1 | | | | | | |
| SiPU control sample 3-2 | N/A | N/A | 0.05 | 22.7 ± 2 | Clear | CE |
| Silicone/SiPU blend | No | N/A | 0.05 | 30.5 ± 6 | Clear | CE |
| sample 3-3 | | | | | | |
| Extended SiPU | N/A | N/A | 0.09 | 60.4 ± 0.2 | Clear | CE |
| sample 3-4 | | | | | | |
| 2.5% Dodecyl vinyl | Yes | 16.6 | 0.05 | 40.4 ± 7 | Clear | IE |
| ether sample 3-5 | | | | | | |
| 2.5% Vinyl laurate | Yes | 17.8 | 0.04 | 37.7 ± 1 | Clear | IE |
| sample 3-6 | | | | | | |
| 2.5% 1,4-cyclohexane | Yes | 17.4 | 0.05 | 42.1 ± 3 | Clear | IE |
| dimethanol divinyl | | | | | | |
| ether sample 3-7 | | | | | | |
| 2.5% Pentaerythritol | No | 30.5 | 0.05 | 16.7 ± 5 | Opaque | CE |
| allyl ether sample 3-8 | | | | | | |
| 2.5% Trimethylolpropane | No | 19.9 | 0.05 | 25.7 ± 3 | Clear | CE |
| trimethacrylate | | | | | | |
| sample 3-9 | | | | | | |
| Silicone resin/SiPU | No | N/A | 0.05 | 25.5 ± 1 | Clear | CE |
| blend 3-10 | | | | | | |

In the table above, N/A means not applicable.

### Test Methods

Unless otherwise indicated, viscosity was measured at 25° C. using a Cone/Plate viscometer with Spindle CP-52 at 12 RPM.

Solubility Parameters reported herein are at 25° C. and were calculated using the method of Fedors in the article “A Method for Estimating Both the Solubility Parameters and Molar Volumes of Liquids” by Robert F. Fedors, Jet Propulsion Laboratory, California Institute of Technology, Pasadena, California, POLYMER ENGINEERING AND SCIENCE, FEBRUARY, 1974, Vol. 14, No. 2, pages 147-154. Briefly stated, the solubility parameter, δ, at a given temperature is given by the equation δ=(ΔEᵥ/V)^{1/2}, where ΔEᵥ is the energy of vaporization at a given temperature, and V is the corresponding molar volume, which is calculated from the known values of molecular weight and density. The heat of vaporization, ΔHᵥ, can be measured and used to calculate where ΔEᵥ according to the formula ΔEᵥ=ΔHᵥ−RT, where R is the gas constant in the appropriate units and T is the absolute temperature.

### INDUSTRIAL APPLICABILITY

There is an industry need to provide stabilized compositions to synergistically capture property benefits of polyorganosiloxanes and urethanes in stable, transparent, UV-curable compositions. The present invention provides a curable composition that is stable (does not phase separate when tested as described in Reference Example 1, above) and can cure to form a transparent film. Furthermore, the transparent film may have a high Shore M hardness, e.g., higher Shore M hardness than when an unstable system (i.e., composition that phase separates when tested as described in Reference Example 1) is prepared. For example, Samples 3-5, 3-6, and 3-7 each cured to form clear films when 2.5% of a reactive diluent corresponding to starting material (C) of this invention was combined with an equal weight mixture of starting materials (A-1) and (B-1) in Table 1. However, when 2.5% of either pentaerythritol allyl ether or trimethylolpropane trimethacrylate was combined with the an equal weight mixture of starting materials (A-1) and (B-1), the resulting cured film had lower Shore M hardness, as shown by comparative samples 3-8 and 3-9 when compared to working samples 3-5, 3-6, and 3-7.

### Definitions and Usage of Terms

All amounts, ratios, and percentages herein are by weight, unless otherwise indicated by the context of the specification. The articles ‘a’, ‘an’, and ‘the’ each refer to one or more, unless otherwise indicated by the context of specification. The singular includes the plural unless otherwise indicated by the context of the specification. The SUMMARY and ABSTRACT are hereby incorporated by reference. The amounts of all starting materials in a composition total 100%. The transitional phrases “comprising”, “consisting essentially of”, and “consisting of” are used as described in the Manual of Patent Examining Procedure Ninth Edition, Revision 08.2017, Last Revised January 2018 at section § 2111.03 I., II., and III. Any feature or aspect of the invention may be used in combination with any other feature or aspect recited herein. The abbreviations used herein have the definitions in Table A, below.

TABLE A
Abbreviations

| Abbreviation | Definition |
|---|---|
| ° C. | Degrees Celsius |
| CE | comparative example |
| cP | centiPoise |
| δ or d | solubility parameter |
| DP | Degree of polymerization |
| D | Difunctional siloxy unit of formula (R₂SiO_{2/2}), where R |
| | may be an alkyl group such as methyl |
| Dow | The Dow Chemical Company of Midland, Michigan USA |
| g | gram |
| GPC | gel permeation chromatography |
| h | hour |
| M | Monofunctional siloxy unit of formula (R₃SiO_{1/2}), where R |
| | may be an alkyl group such as methyl |
| Me | methyl |
| mg | milligram |
| mL | milliliter |
| mmol | millimole |
| Mn | Number average molecular weight |
| MPa | megaPascal |
| Mw | Weight average molecular weight |
| NMR | Nuclear magnetic resonance |
| ppm | part per million |
| RPM or rpm | revolutions per minute |
| RT or r.t. | Room temperature of 23 ± 3° C. |
| s | second |
| IE | working example |

### Embodiments of the Invention

In a first embodiment, a radiation curable siloxane composition comprises:
(A) an ethylenically unsaturated polydiorganosiloxane comprising unit formula (A1): (R⁴₃SiO_{1/2})ₐ(R⁴₂R⁵SiO_{1/2})_{b}(R⁴₂SiO_{2/2})_{c}(R⁴R⁵SiO_{2/2})_{d}, where
   each R⁴ is an independently selected monovalent hydrocarbyl group free of aliphatic unsaturation;
   each R⁵ is an ethylenically unsaturated monovalent hydrocarbyl group of 2 to 12 carbon atoms;
   subscripts a, b, c, and d, each represent an average number of siloxane units per molecule and have values such that
      0≤a≤2,
      0≤b≤2,
         (a+b)=2,
      c≥0,
      d≥0,
         10≤(c+d)≤1,000, and
         (b+d)≥2;
(B) a radical curable siloxane-urethane/urea copolymer comprising formula (B1):

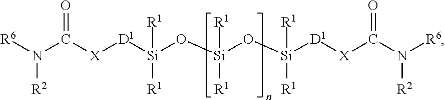

where
each R² is an independently selected ethylenically unsaturated monovalent hydrocarbyl group,
each R⁶ is independently selected from H or R²,
each X is independently selected from O or NH,
each D¹ is a divalent hydrocarbyl group or an oxyhydrocarbyl group,
each R¹ is an independently selected monovalent hydrocarbyl group that is free of aliphatic unsaturation, and
subscript n≥0, and
(C) a reactive diluent distinct from starting materials (A) and (B), and starting material (C) comprises, per molecule, at least one radical curable group selected from the group consisting of vinyl, vinyl ether, acrylate, and methacrylate; and starting material (C) has a solubility parameter δ≤19 (MPa)^{1/2} when estimated by method of Fedors in which the solubility parameter, δ, at a given temperature is given by equation δ=(ΔEᵥ/V)^{1/2}, where ΔEᵥ is energy of vaporization at a given temperature, and V is a corresponding molar volume, which is calculated from known values of molecular weight and density, and heat of vaporization, ΔHᵥ, can be measured and used to calculate where ΔEᵥ according to the formula ΔEᵥ=ΔHᵥ−RT, where R is gas constant in appropriate units and T is absolute temperature;
(D) a crosslinker; and
(E) a photoinitiator.

In a second embodiment, in the composition of the first embodiment,
starting material (A) the ethylenically unsaturated polydiorganosiloxane is present in an amount of 30 weight % to 40 weight %, based on combined weights of starting materials (A), (B), (C), (D), and (E);
starting material (B) the siloxane-urethane copolymer is present in an amount of 30 weight % to 40 weight %, based on combined weights of starting materials (A), (B), (C), (D), and (E);
starting material (C) the reactive diluent is present in an amount of >0 to 25 weight %, alternatively 1 weight % to 5 weight %, based on combined weights of starting materials (A), (B), (C), (D), and (E);
starting material (D) the crosslinker is present in an amount of 20 weight % to 35 weight %, based on combined weights of starting materials (A), (B), (C), (D), and (E); and
starting material (E) the photoinitiator is present in an amount of >0 to 1 weight %, based on combined weights of starting materials (A), (B), (C), (D), and (E).

In a third embodiment, the composition of the first embodiment or the second embodiment further comprises an additional starting material in an amount of >0 to 30 weight %, where the additional starting material is selected from the group consisting of: (F) a filler, (G) a stabilizer, (H) a UV absorber, (I) an adhesion promoter, (J) an alkenyl functional polyorganosiloxane resin, and a combination of two or more thereof, where combined amounts of all starting materials in the composition total 100 weight %.

In a fourth embodiment, in the composition of any one of the first to third embodiments, starting material (A) comprises formula (A2):

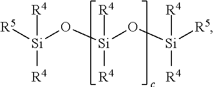

where
each R⁴ is alkyl,
each R⁵ is independently selected from the group consisting of vinyl, allyl, and hexenyl, and
10≤c≤260.

In a fifth embodiment, in the composition of the fourth embodiment, in formula (A2) each R⁴ is methyl, each R⁵ is vinyl, and 10≤c≤200.

In a sixth embodiment, in the composition of any one of the first to fifth embodiments, where starting material (B) comprises formula (B2):

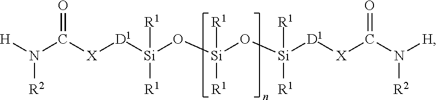

where
each R² is an independently selected ethylenically unsaturated monovalent hydrocarbyl group,
each X is independently selected from O or NH,
each D¹ is a divalent hydrocarbyl group or oxyhydrocarbyl group,
each R¹ is an independently selected monovalent hydrocarbyl group that is free of aliphatic unsaturation, and
10≤n≤110.

In a seventh embodiment, in the composition of the sixth embodiment, in formula (B2), each R² is allyl, each X is 0, each D¹ is an oxyhydrocarbyl group, and 20≤n≤100.

In an eighth embodiment, in the composition of any one of the first to seventh embodiments, starting material (B) comprises a copolymer of formula:

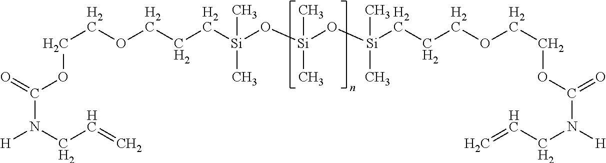

where subscript n is 50 to 70.

In a ninth embodiment, in the composition of any one of the first to eighth embodiments, starting material (C) has a viscosity <1,000 cP measured at 25° C. using a Cone/Plate viscometer with Spindle CP-52 at 12 RPM.

In a tenth embodiment, in the composition of any one of the first to ninth embodiments, starting material (C) comprises a vinyl functional compound comprising tetrakis(dimethyl(vinyl)silyl) silicate.

In an eleventh embodiment, in the composition of any one of the first to ninth embodiments, starting material (C) is a (meth)acrylate-functional compound selected from the group consisting of isobornyl methacrylate, lauryl methacrylate, vinyl laurate, 3-methacryloxypropyltrimethoxysilane, and a combination of two or more thereof.

In a twelfth embodiment, in the composition of any one of the first to ninth embodiments, starting material (C) is a vinyl ether-functional compound selected from the group consisting of 1,4-cyclohexanedimethanol divinyl ether, isobutyl vinyl ether, dodecyl vinyl ether, and a combination of two or more thereof.

In a thirteenth embodiment, a method for making a transparent cured film comprises:
1) preparing the composition of any one of the first to twelfth embodiments by mixing starting materials comprising (A), (B), (C), and (D);
2) forming composition into a liquid film, and
3) exposing the liquid film to UV radiation, thereby forming the transparent cured film.

In a fourteenth embodiment, in the method of the thirteenth embodiment, the transparent cured film is a coating.

In a fifteenth embodiment, in the method of the thirteenth embodiment or the fourteenth embodiment, the transparent cured film is a conformal coating.

1. A composition comprising starting materials (A), (B), and (C), where
starting material (A) is an ethylenically unsaturated polydiorganosiloxane comprising unit formula (A1): (R⁴₃SiO_{1/2})ₐ(R⁴₂R⁵SiO_{1/2})_{b}(R⁴₂SiO_{2/2})_{c}(R⁴R⁵SiO_{2/2})_{d}, where
each R⁴ is an independently selected monovalent hydrocarbyl group free of aliphatic unsaturation;
each R⁵ is an ethylenically unsaturated monovalent hydrocarbyl group of 2 to 12 carbon atoms;
subscripts a, b, c, and d, each represent an average number of siloxane units per molecule and have values such that
0≤a≤2,
0≤b≤2,
(a+b)=2,
c≥0,
d≥0,
10≤(c+d)≤1,000, and
(b+d)≥2;
starting material (B) is a radical curable siloxane-urethane/urea copolymer comprising formula (B1): 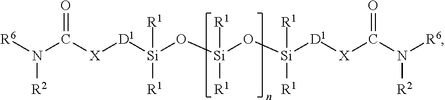
where
each R² is an independently selected ethylenically unsaturated monovalent hydrocarbyl group,
each R⁶ is independently selected from H or R²,
each X is independently selected from O or NH,
each D¹ is a divalent hydrocarbyl group or an oxyhydrocarbyl group,
each R¹ is an independently selected monovalent hydrocarbyl group that is free of aliphatic unsaturation, and
subscript n≥0, and
starting material (C) is a reactive diluent distinct from starting materials (A) and (B), and starting material (C) comprises, per molecule, at least one radical curable group selected from the group consisting of vinyl, vinyl ether, acrylate, and methacrylate; and starting material (C) has a solubility parameter δ≤19 (MPa)^{1/2} when estimated by method of Fedors.

2. The composition of claim 1, where starting material (A) comprises formula (A2): 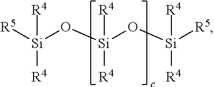
where
each R⁴ is alkyl,
each R⁵ is independently selected from the group consisting of vinyl, allyl, and hexenyl, and
10≤c≤260.

3. The composition of claim 2, where in formula (A2) each R⁴ is methyl, each R⁵ is vinyl, and 10≤c≤200.

4. The composition of claim 1, where starting material (B) comprises formula (B2): 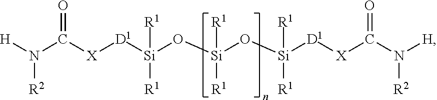
where
each R² is an independently selected ethylenically unsaturated monovalent hydrocarbyl group,
each X is independently selected from O or NH,
each D¹ is a divalent hydrocarbyl group or oxyhydrocarbyl group,
each R¹ is an independently selected monovalent hydrocarbyl group that is free of aliphatic unsaturation, and
10≤n≤110.

5. The composition of claim 4, where in formula (B2), each R² is allyl, each X is O, each D¹ is an oxyhydrocarbyl group, and 20≤n≤100.

6. The composition of claim 5, where starting material (B) comprises a copolymer of formula: 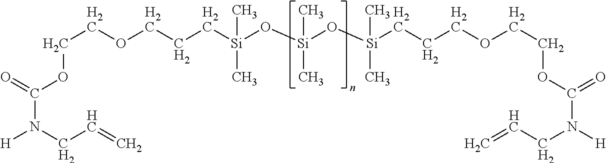
where subscript n is 50 to 70.

7. The composition of claim 1, where starting material (C) has a viscosity <1,000 cP.

8. The composition of claim 1, where starting material (C) comprises a vinyl functional compound comprising tetrakis(dimethyl(vinyl)silyl) silicate.

9. The composition of claim 1, where starting material (C) is a (meth)acrylate-functional compound selected from the group consisting of isobornyl methacrylate, lauryl methacrylate, vinyl laurate, 3-methacryloxypropyltrimethoxysilane, and a combination of two or more thereof.

10. The composition of claim 1, where starting material (C) is a vinyl ether-functional compound selected from the group consisting of 1,4-cyclohexanedimethanol divinyl ether, isobutyl vinyl ether, dodecyl vinyl ether, and a combination of two or more thereof.

11. The composition of claim 1, further comprising an additional starting material selected from the group consisting of: (D) a crosslinker, (E) a photoinitiator, (F) a filler, (G) a stabilizer, (H) a UV absorber, (I) an adhesion promoter, (J) an alkenyl functional polyorganosiloxane resin, and a combination of two or more thereof.

12. The composition of claim 11, where starting materials (A), (B), (C), (D), and (E) are present in the composition, and
starting material (A) the ethylenically unsaturated polydiorganosiloxane is present in an amount of 30 weight % to 40 weight %, based on combined weights of starting materials (A), (B), (C), (D), and (E);
starting material (B) the siloxane-urethane copolymer is present in an amount of 30 weight % to 40 weight %, based on combined weights of starting materials (A), (B), (C), (D), and (E);
starting material (C) the reactive diluent is present in an amount of >0 to 25 weight %, alternatively 1 weight % to 5 weight %, based on combined weights of starting materials (A), (B), (C), (D), and (E);
starting material (D) the crosslinker is present in an amount of 20 weight % to 35 weight %, based on combined weights of starting materials (A), (B), (C), (D), and (E); and
starting material (E) the photoinitiator is present in an amount of >0 to 1 weight %, based on combined weights of starting materials (A), (B), (C), (D), and (E).

13. A method for making the composition of claim 11, wherein the method comprises mixing starting materials comprising (A), (B), (C), (D), and (E), where
starting material (A) is an ethylenically unsaturated polydiorganosiloxane comprising unit formula (A1): (R⁴₃SiO_{1/2})ₐ(R⁴₂R⁵SiO_{1/2})_{b}(R⁴₂SiO_{2/2})_{c}(R⁴R⁵SiO_{2/2})_{d}, where
each R⁴ is an independently selected monovalent hydrocarbyl group free of aliphatic unsaturation;
each R⁵ is an ethylenically unsaturated monovalent hydrocarbyl group of 2 to 12 carbon atoms;
subscripts a, b, c, and d, each represent an average number of siloxane units per molecule and have values such that
0≤a≤2,
0≤b≤2
(a+b)=2,
c≥0,
d≥0,
10≤(c+d)≤1,000 and
(b+d)≥2;
starting material (B) is a radical curable siloxane-urethane/urea copolymer comprising formula (B1): 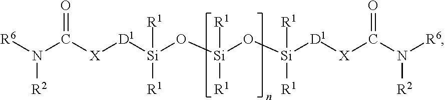
where
each R² is an independently selected ethylenically unsaturated monovalent hydrocarbyl group,
each R⁶ is independently selected from H or R²,
each X is independently selected from O or NH,
each D¹ is a divalent hydrocarbyl group or an oxyhydrocarbyl group,
each R¹ is an independently selected monovalent hydrocarbyl group that is free of aliphatic unsaturation, and
subscript n≥0, and
starting material (C) is a reactive diluent distinct from starting materials (A) and (B), and starting material (C) comprises, per molecule, at least one radical curable group selected from the group consisting of vinyl, vinyl ether, acrylate, and methacrylate; and starting material (C) has a solubility parameter δ≤19 (MPa)^{1/2} when estimated by method of Fedors,
starting material (D) is a crosslinker, and
starting material (E) is a photoinitiator.

14. A method for making a transparent cured film, wherein the method comprises;
1) preparing a composition by a method comprising mixing starting materials comprising (A) (B), (C), (D) and (E), where
starting material (A) is an ethylenically unsaturated polydiorganosiloxane comprising unit formula (A1): (R⁴₃SiO_{1/2})ₐ(R⁴₂R⁵SiO_{1/2})_{b}(R⁴₂SiO_{2/2})_{c}(R⁴R⁵SiO_{2/2})_{d}, where
each R⁴ is an independently selected monovalent hydrocarbyl group free of aliphatic unsaturation;
each R⁵ is an ethylenically unsaturated monovalent hydrocarbyl group of 2 to 12 carbon atoms;
subscripts a, b, c, and d, each represent an average number of siloxane units per molecule and have values such that
0≤a≤2,
0≤b≤2,
(a+b)=2,
c≥0,
d≥0,
10≤(c+d)≥1,000, and
(b+d)≥2;
starting material (B) is a radical curable siloxane-urethane/urea copolymer comprising formula (B1): 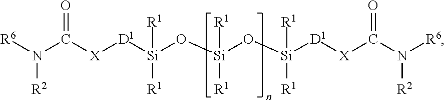
where
each R² is an independently selected ethylenically unsaturated monovalent hydrocarbyl group;
each R⁶ is independently selected from H or R²,
each X is independently selected from O or NH,
each D¹ is a divalent hydrocarbyl group or an oxyhydrocarbyl group,
each R¹ an independently selected monovalent hydrocarbyl group that is free of aliphatic unsaturation, and
subscript n≥0, and
starting material (C) is a reactive diluent distinct from starting materials (A) and (B), and starting material (C) comprises, per molecule, at least one radical curable group selected from the group consisting of vinyl, vinyl ether, acrylate, and methacrylate; and starting material (C) has a solubility parameter δ≤19 (MPa)^{1/2} when estimated by method of Fedors,
starting material (D) is a crosslinker, and
starting material (B) is a photoinitiator,
2) forming the composition into a liquid film, and
3) exposing the liquid film to UV radiation, thereby forming the transparent cured film.

15. The method of claim 14, where the transparent cured film is a coating.

16. The method of claim 14, where starting material (A) comprises formula (A2); 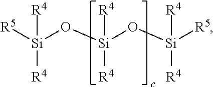
where
each R⁴ is alkyl
each R⁵ is independently selected from the group consisting of vinyl, allyl, and hexenyl, and
10≤c≤260.

17. The method of claim 14, where starting material (B) comprises formula (B2): 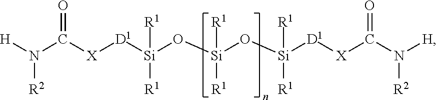
where
each R² is an independently selected ethylenically unsaturated monovalent hydrocarbyl group,
each X is independently selected from O or NH,
each D¹ is a divalent hydrocarbyl group or oxyhydrocarbyl group,
each R¹ is an independently selected monovalent hydrocarbyl group that is free of aliphatic unsaturation, and
10≤n≤110.

18. The method of claim 14, where starting material (C) comprises a vinyl functional compound comprising tetrakis(dimethyl(vinyl)silyl) silicate.

19. The method of claim 14, where starting material (C) is a (meth)acrylate-functional compound selected from the group consisting of isobornyl methacrylate, lauryl methacrylate, vinyl laurate, 3-methacryloxypropyltrimethoxysilane, and a combination of two or more thereof.
